(19) United States
(12) Patent Application Publication
(10) Pub. No.: US 2013/0247310 A1
(43) Pub. Date: Sep. 26, 2013

(54) Gangway for Embarking and Disembarking Passengers

(71) Applicant: Pere Bonvila Bonet, Barcelona (ES)

(72) Inventor: Pere Bonvila Bonet, Barcelona (ES)

(73) Assignee: Team, Ports & Maritime, S.L., Barcelona (ES)

(21) Appl. No.: 13/989,657

(22) PCT Filed: Nov. 25, 2011
(86) PCT No.: PCT/ES2011/070818

§ 371 Date: Jun. 12, 2013

(30) Foreign Application Priority Data
Nov. 25, 2010 (EP) P21031729

(51) Int. Cl. B64F 1/305

(52) U.S. Cl. CPC B64F 1/3055
USPC 14/71.1

(57) ABSTRACT

A gangway for embarking and disembarking passengers comprises a first module with a plurality of ramps located at different heights and joined at their ends by union modules, defining an entrance and an exit towards a second module, and a pair of movable support structures located at opposite ends of the first module. The second module comprises a plurality of telescopic tunnels that can be extended relative to one another, one of the ends of the outermost tunnel being coupled to a cabin that can be coupled to the ship; a movable gantry structure that allows the height of the second module to be regulated; and a motor-less revolving platform coupled to the first and second modules and supported on a movable support structure that rotates about its own vertical axis.

### OBJECT OF THE INVENTION

The present application for a patent of invention has as object the registration of a gangway for embarking and disembarking passengers, incorporating substantial innovations and advantages.

The field of application of the present invention is the industry of manufacture of port equipments and structures, specially those aimed at facilitating the docking manoeuvres of passenger ships and embarking and disembarking passengers.

### BACKGROUND OF THE INVENTION

Installations and equipments to permit the embarking and disembarking passengers to/from a ship after its docking in the port are well known in the state of the art, being of the type which comprises a support structure holding one or more extendible or telescopic tunnels along which the passengers may pass, which tunnels are coupled by one end to a point of access to the ship while at the other end they are coupled to a stationary terminal.

However, the installations which are currently used, due to its general construction, are not convenient to use as they have a limited height, mainly due to the arrangement of the stationary terminal in a location of the port area.

### DESCRIPTION OF THE INVENTION

This invention has been developed with the aim to provide a gangway which solves the abovementioned drawbacks, additionally contributing other advantages which will be evident from the following description.

It is therefore an object of the invention to provide a gangway for the embarking and disembarking of passengers from a port installation up to the interior of a ship or vice versa, characterised by comprising:
a first module having a plurality of ramps located at different heights, said ramps being connected by its ends by means of union modules, defining an entrance point and a point of exit towards the second module, as well as a pair of support structures which are movable on the horizontal plane, being located at the opposed ends of the first module;
the second module has a plurality of telescopic and extendible tunnels each of them with a substantially parallelepiped form, one of the ends of the outermost tunnel being coupled to a cabin substantially coupled to the ship, and having a gantry structure which is movable in such a way that said second module may be adjusted in height, being adapted to the height between said first module and the ship; and
a rotating platform without driving motors, which is coupled to the first and the second modules, supported by a movable support structure capable to rotate in respect to its own vertical axis.

Due to these characteristics, a gangway is made up in which use there is no need that the port installation has a terminal building, because the first module has the role of terminal, so that it may be used in whatever adequate location of the port. Furthermore, another not less important advantage of the gangway of the invention consists in the fact that for being movable it may be located at different points of the port as required, so that the mooring manoeuvres of the passenger ships as well as the embarking and disembarking of the passengers are made easier.

Other particulars and advantageous aspects of the gangway, according to the invention, are the object of the dependent claims.

Other characteristics and advantages of the gangway which is the object of the invention will be evident from the description of a preferred, although not exclusive embodiment illustrated as a non limitative example in the annexed drawings, in which:

### BRIEF DESCRIPTION OF THE DRAWINGS

FIG. 1 is a perspective view of a gangway for the embarking and disembarking of passengers according to the present invention;

FIG. 2 is a detailed perspective view of the first module of the gangway of the invention;

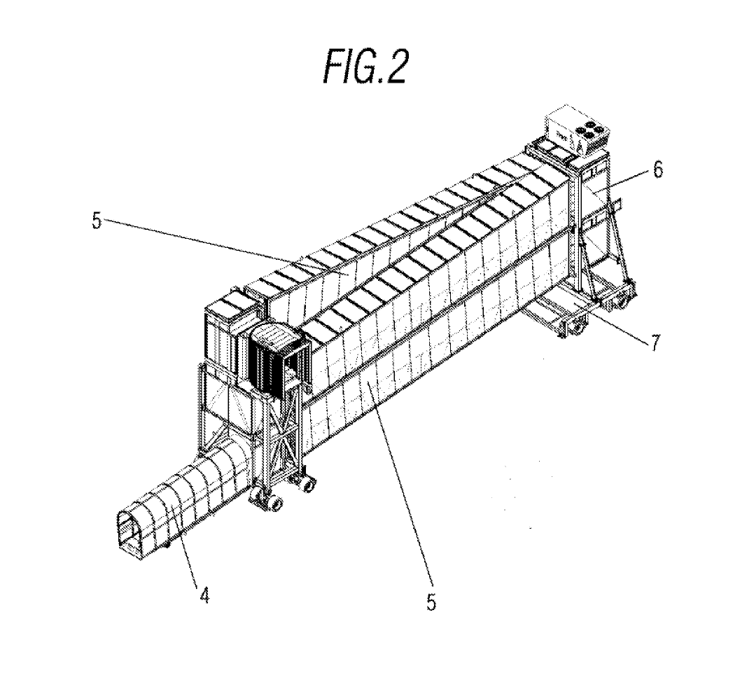

FIG. 3 is a detailed perspective view of the second module of the gangway of the invention with tunnels in a retracted position;

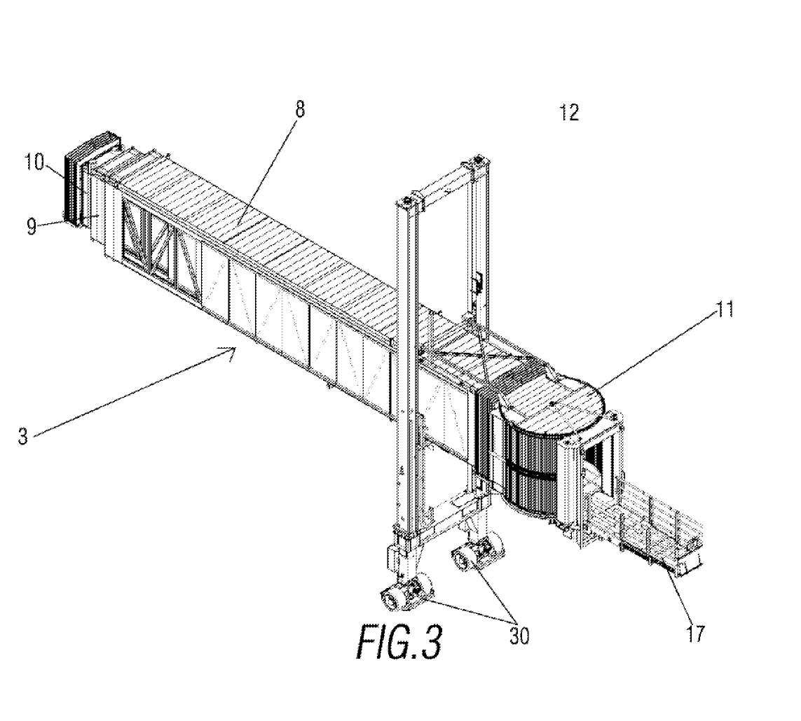

FIG. 4 is a perspective view of the gantry structure of the second module;

FIG. 5 is a perspective view of the rotating platform;

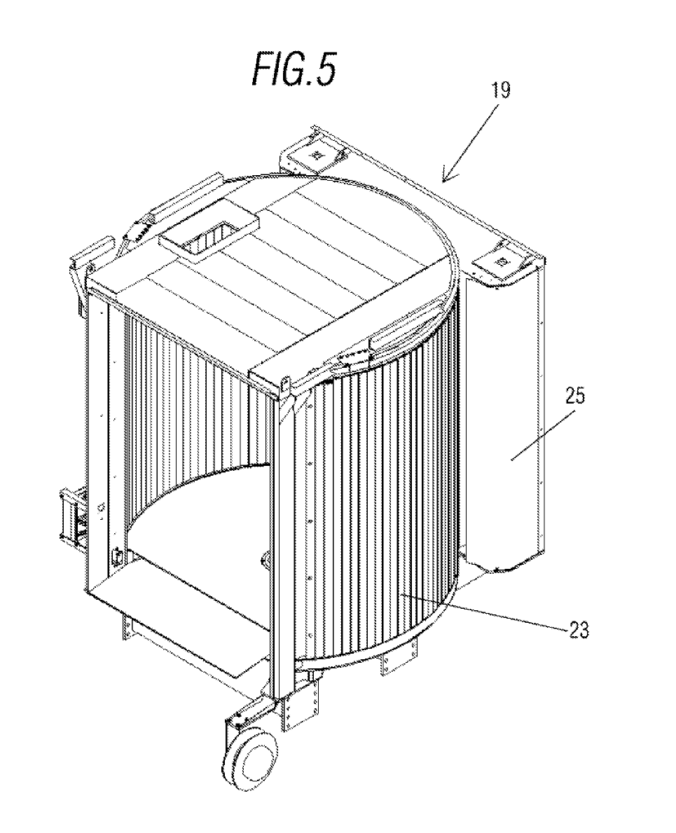

FIG. 6 is a perspective view of the rotating platform after 90° rotation to show the lower part of the platform;

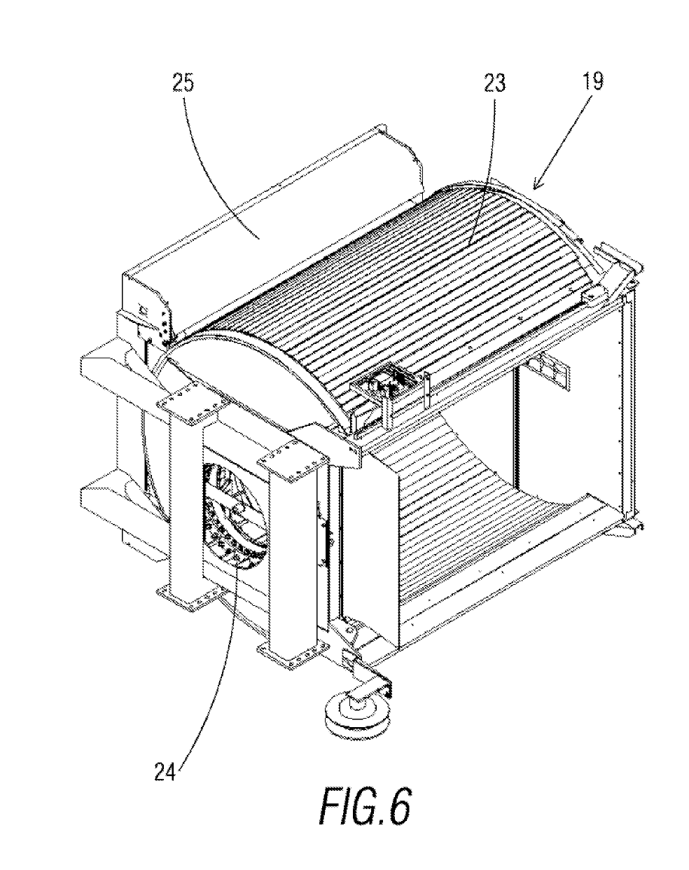

FIG. 7 is a perspective view of a cabin which may be coupled to the ship, arranged in the second module of the gangway; and

FIG. 8 is a perspective view of the structure supporting the rotating platform.

### DESCRIPTION OF A PREFERRED EMBODIMENT

In the figures, a gangway is shown for the embarking and disembarking of passengers is shown generally indicated with the numeral 1, corresponding to the type aimed at making possible the access of passengers from a port installation up to the interior of a ship or vice versa.

Particularly, said gangway has a first module generally indicated with the numeral 2, having an access ramp 4 with access from the level of the ground and a plurality of ramps 5 coupled by its ends by means of union modules 6, defining an entrance point and a point of exit towards a second module 3 generally indicated with the numeral 3, the module having as well a pair of movable support structures 7 located at opposing ends. Both support structures 7 have bottom wheels for its displacement.

The union modules 6 have partially closed enclosures having securing means for engagement to ramps 5. As to be seen, ramps 5, which form part of the first module 2, are closed by the sides and top portions by respective covers having said covers transparent sections.

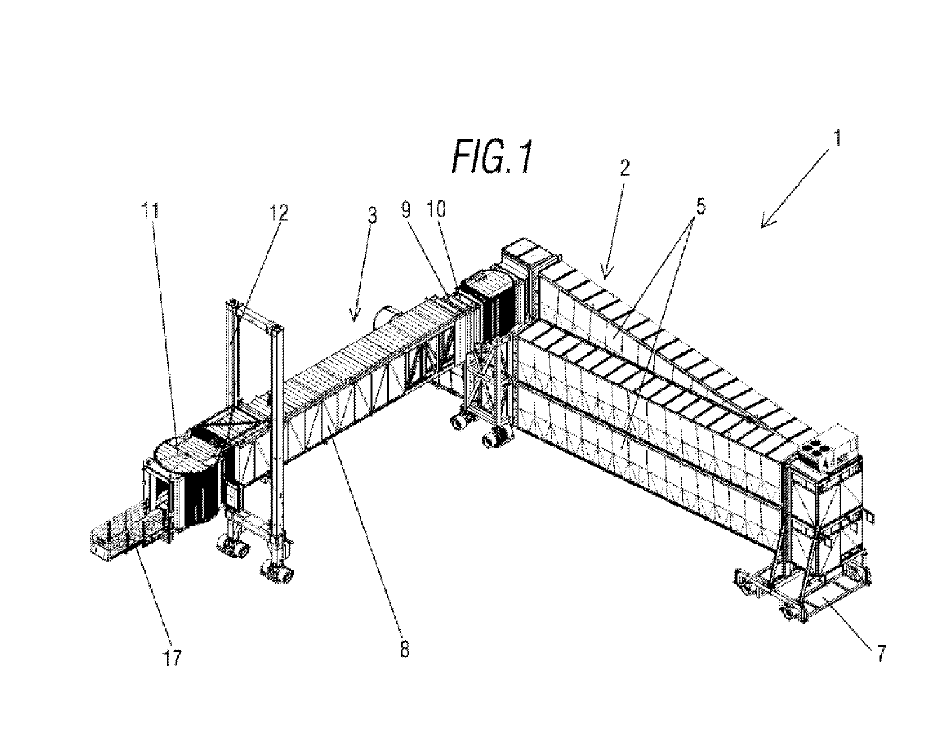

In FIG. 1 way be seen that the first module 2 adopts a 90 degrees arrangement in respect to the second module 3 although said arrangement may vary in its angle due to the presence of rotation systems, as will be explained below.

The second module 3 has three telescopic tunnels 8, 9, 10 which are mutually extendible, with a rectangular transverse section, having therefore each of the tunnels a generally parallelepiped form, being one of the ends of outermost tunnel coupled to a cabin 11 to be joined to the ship to or from which the passengers have to embark or disembark, and the module is associated to a movable gantry structure 12 (to be explained below) so that said second module 3 is adjustable in its height.

The cabin 11 is formed by a generally cylindrical body 13 which has a bottom base, a side wall with two access openings and an upper deck, the bottom base including a rotating coupling portion and guiding means for coupling to the telescopic tunnel which has a bigger transverse section. On the other side, the top part of said cabin 11 has a rotating axis 14 from which a pair of V arranged struts 15 protrude, being secured by its ends to a frame 16, in concrete terms in the upper portion of the frame, with an inverted “U” form which is capable to oscillate in an horizontal plane following the cylindrical outline of the side wall of the cabin 11. In this way, the cabin 11 adapts to the eventual oscillating movements caused by the waves.

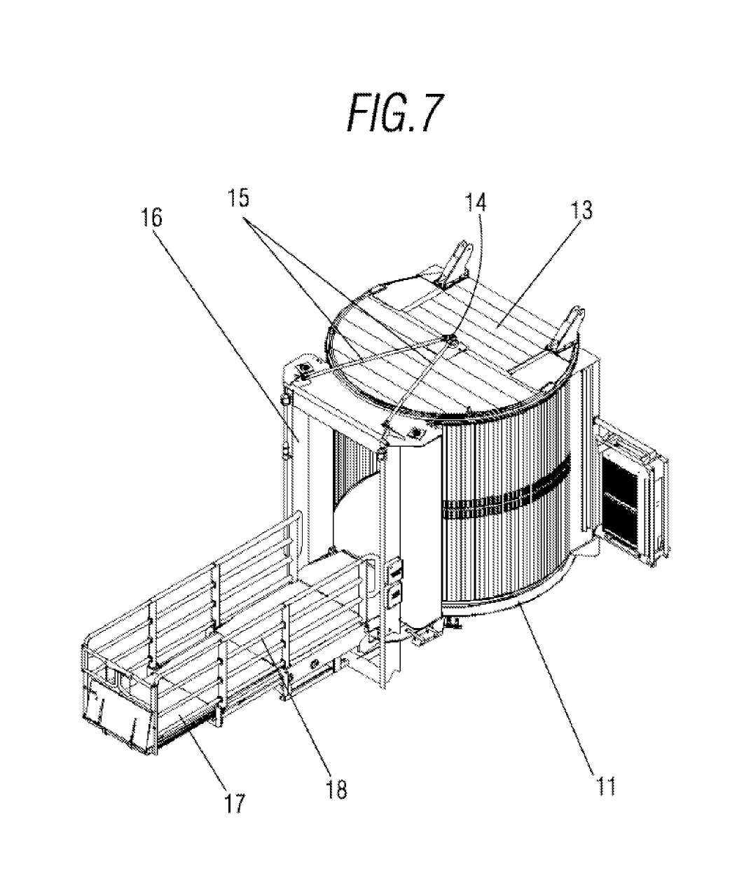

Said frame 16 is secured to a horizontal platform 17 by conventional securing means and has at the sides protection railings 18, said platform being in direct contact with the ship when the gangway 1 is in operation, as shown in FIG. 7.

The telescopic tunnels 8, 9, 10 have an extension/retraction system formed by multiple pulleys and cables permitting the mutual adaptation of the three telescopic tunnels 8, 9, 10. Said system is used in other gangways described in patents of the same owner of the present invention.

Additionally, a motor-less rotating platform 19 is arranged coupled to the first and second modules 2, 3 supported by a movable support structure 20 capable to rotate in respect of its vertical axis. As said rotating platform 11 does not have propulsion means, it carries out its rotation by the movement caused by the second module.

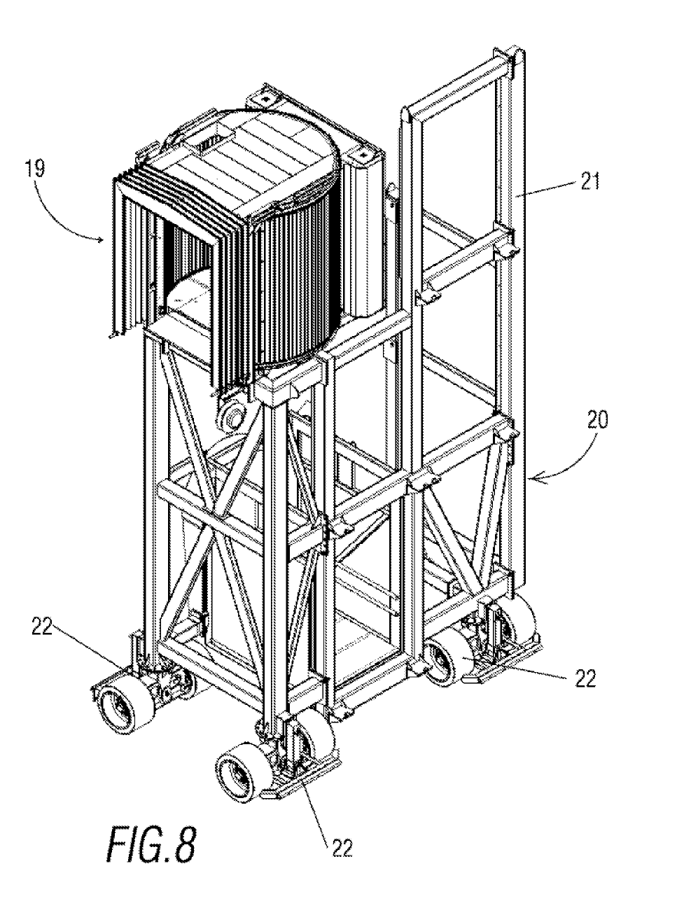

As to be more clearly seen in FIG. 8, the support structure 20 of the rotating platform has a plurality of vertical, horizontal and inclined metal profiles 21 and four sets of wheels 22 for its displacement, located at the lower part of said structure 20, which corresponds with one of the support structures for the tunnels 8, 9, 10.

The above mentioned rotating platform 19 comprises a generally cylindrical body 23 which has a bottom base, a side wall having at least two access openings and an upper deck, having the lower base a rotating coupling portion 24 and guiding means to couple to the telescopic tunnel with smaller transverse section located in the second module 3. These guiding means comprise mainly a frame 25 which may be adapted to the telescopic tunnel with a smaller transverse section.

The structure of the gantry 12 is made out by two opposed vertical metal posts 26 and two metal horizontal upper and lower crossbars 27, a pair of support elements 28 having been provided being vertically displaceable by means of a conventional electromechanical system (not shown), being guided along the slotted sections 29 arranged longitudinally at the internal side of each of the vertical posts 26 on which the outermost tunnel 8 is supported, both support elements 28 being movable by motor means. In this way, the height of the second module 3 may be regulated in a simple and quick manner.

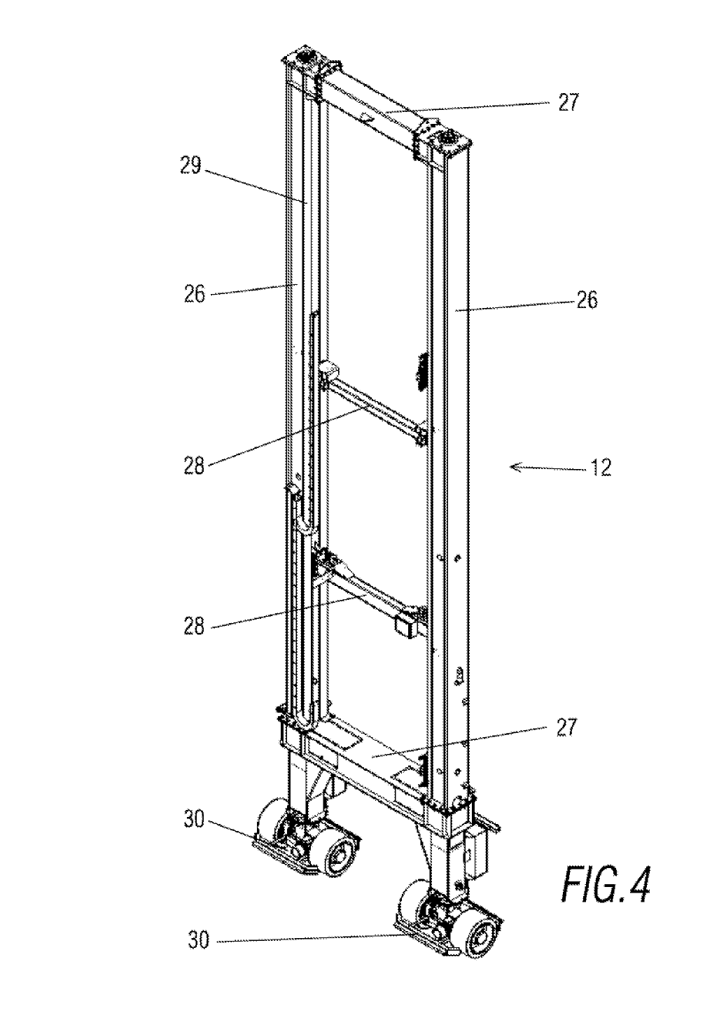

As shown in FIG. 4, the structure of the gantry 12 includes at the bottom part two sets of wheels 30 to permit its movement, having each of them motor means to carry out displacement movements.

Although the whole gangway has been shown having motor driven wheels, it is eventually possible for the gangway to be dragged along by a tractor vehicle.

The details, shape, dimensions and other accessory elements as well as the materials used for the manufacture of the gangway of the invention may be conveniently substituted by other technically equivalent, not departing from the essentials of the invention nor from its scope as defined by the claims which follow.

1. Gangway (1) for embarking and disembarking passengers, of the type aimed at enabling the access of passengers from a port installation up to the interior of a ship or vice versa, characterised in that it comprises:
a first module (2) having a plurality of ramps (5) located at different heights, being said ramps joined by its ends by means of union modules (6) defining an entrance point and a point of exit towards the second module (3) and a pair of movable support structures (7) located at the opposed ends of the first module (2);
having the second module (3) a plurality of mutually extendible telescopic tunnels (8, 9, 10) having each one of them a generally parallelepiped form, being one of the ends of the outermost tunnel coupled to a cabin which may be coupled to the ship, and having a gantry structure (12) movable in such a way that said second module (3) is regulatable in height; and
a motor-less rotating platform (19) coupled to the first and second modules, supported by a movable support structure capable to rotate in respect to its own vertical axis.

2. Gangway (1) for the embarking and disembarking of passengers, according to claim 1, characterised in that the support structure for the rotating platform (19) has in its lower portion a plurality of metal profiles and wheels for its displacement.

3. Gangway (1) for the embarking and disembarking of passengers, according to claim 1, characterised in that the rotating platform (19) has a generally cylindrical body (23) with a bottom base, a side wall having at least two access openings and a top deck, having the lower base a rotating coupling portion and means for guidance and coupling to be coupled to the telescopic tunnel with smaller transverse section located at the second module (3).

4. Gangway (1) for the embarking and disembarking of passengers, according to claim 1, characterised in that the gantry structure (12) is made out of two vertical posts (26) and two, upper and lower, horizontal crossbars (27), at least one vertically displaceable support element (28) being arranged in a guided form along slotted sections (29) arranged at the internal side of the vertical posts (26) on which the external tunnel is supported, being displaced the at least one support element (28) by means of driving motors.

5. Gangway (1) for the embarking and disembarking of passengers, according to claim 4, characterised for having two support elements (28) between which the outermost tunnel is located, which elements are vertically displaceable in a synchronised way.

6. Gangway (1) for the embarking and disembarking of passengers, according to claim 1, characterised in that the union modules (6) have partially closed enclosures having an opening for the access of passengers from one ramp to the next ramp, having securing means for its coupling to the ramps.

7. Gangway (1) for the embarking and disembarking of passengers, according to claim 1, characterised in that the ramps (5) which form the first module (2) are closed at the sides and at the top by means of covers, having the lateral covers transparent sections.
